(19) United States
(12) Patent Application Publication
(10) Pub. No.: US 2024/0246863 A1
(43) Pub. Date: Jul. 25, 2024

(54) LOW-DIELECTRIC WOLLASTONITE BASED LOW-TEMPERATURE CO-FIRED CERAMIC MATERIAL AND PREPARATION METHOD THEREFOR

(71) Applicant: JIAXING GLEAD ELECTRONICS CO., LTD, Zhejiang (CN)

(72) Inventors: Jin LI, Zhejiang (CN); Zugao YU, Zhejiang (CN); Jingang TAN, Zhejiang (CN); Shan SHI, Zhejiang (CN); Jianjun LU, Zhejiang (CN); Jianxi TONG, Zhejiang (CN)

(73) Assignee: JIAXING GLEAD ELECTRONICS CO., LTD, Zhejiang (CN)

(21) Appl. No.: 18/562,338

(22) PCT Filed: Aug. 25, 2022
(86) PCT No.: PCT/CN2022/114695

§ 371 Date: Nov. 20, 2023

(30) Foreign Application Priority Data
Feb. 28, 2022 (CN) 202210188646.1

(51) Int. Cl. C04B 35/22; C04B 35/626; C04B 35/63; C04B 35/634

(52) U.S. Cl. CPC C04B 35/22; C04B 35/6262; C04B 35/6264; C04B 35/62655; C04B 35/62695; C04B 35/6303; C04B 35/63416; C04B 2235/3203; C04B 2235/3206; C04B 2235/3215; C04B 2235/3227; C04B 2235/3267; C04B 2235/3275; C04B 2235/3281; C04B 2235/3284; C04B 2235/3298; C04B 2235/3409; C04B 2235/3418; C04B 2235/3454; C04B 2235/442; C04B 2235/604; C04B 2235/6567; C04B 2235/661

(57) ABSTRACT

The present disclosure relates to the technical field of electronic materials. A low-dielectric wollastonite based low-temperature co-fired ceramic material and a preparation method therefor are provided. The formula of the ceramic material is: CaₓSiO₃+awt % SiO₂+bwt % R₂O+cwt % Bi₂O₃+dwt % B₂O₃+ewt % MO, wherein 0.9≤x≤1.1, 0<a≤30, 1≤b≤5, 0<c≤3, 0<d≤6, 0≤e≤10, R₂O is at least one of Li₂O and K₂O, and MO is one or more of ZnO, MgO, BaO, CoO, CuO, La₂O₃ and MnO₂. The low-temperature co-fired ceramic material provided by the present disclosure satisfies the requirements of low dielectric, low loss and low-temperature sintering, and can be applied to the fields of millimeter wave LTCC devices and the like.

### BACKGROUND

### Technical Field

The disclosure belongs to the technical field of electronic materials, and in particular, relates to a low-dielectric wollastonite based low-temperature co-fired ceramic material and a preparation method therefor.

### Description of Related Art

Low-temperature co-firing ceramics (LTCC) technology is a type of electronic packaging technology, where low-temperature co-fired ceramic materials, device design, and other techniques are included, and the low-temperature co-fired ceramics are the foundation and the key. In recent years, with the rapid development of 5G communication technology, microwave technology is developing towards higher frequencies, that is, towards millimeter waves and sub-millimeter waves. The requirements for low-temperature co-fired ceramic materials have also increased, including: low dielectric constant to reduce the delay time of signals during transmission, high Q value (1/tanδ), that is, low dielectric loss, to reduce the insertion loss of the device and ensure good frequency selection characteristics, and the ability to co-fire with metallic conductive materials such as Ag and Cu at 900° C. In addition, sufficient mechanical strength and environmental reliability shall also be provided, as well as resistance to corrosion by electroplating or electroless plating solutions.

The high-frequency low-dielectric constant low-temperature co-fired ceramic materials currently being studied mainly include three major systems: crystallized glass-ceramics, glass-ceramics, and ceramic-aid. Among them, in the crystallized glass system, the crystallization problem of the material needs to be strictly controlled during the sintering process, which imposes strict requirements on the process. At present, only the A6M material of the American FEERO company is widely used. The glass-ceramic system requires more glass to achieve low-temperature sintering of ceramics, but the problem is a sharp increase in material loss. It is generally difficult for materials in the ceramic-aid system to achieve lower dielectric constants, unlike the glass-ceramic system where glass with lower dielectric constants can be introduced.

(Ca. Mg) SiO₃ series microwave dielectric ceramics have good dielectric properties and low material costs. In the patent CN103193389B, at least two kinds of magnesium oxide, calcium oxide, or silicon oxide are mixed to form a glassy state at 1500° C. to 1800° C., and the total amount of magnesium oxide, calcium oxide, and silicon oxide is 100 mole percent. Materials such as CaTiO₃, MgTiO₃, ZrTiO₄, and TiO₂ are then added to melt at 1500° C. to 1800° C. and then sintered at 900° C. This method has a complicated process and a high dielectric constant. The two melting processes to the glassy state result in a low Q×f value. In the patent application CN112759378A, a CaO—MgO—TiO₂—SiO₂ ceramic material is introduced. In this material, calcium carbonate, magnesium oxide, titanium dioxide, silicon dioxide, manganese oxide, lithium oxide, and bismuth oxide are mixed, directly pre-fired, and then sintered at 860° C. to 880° C. to form low-temperature co-fired ceramics. Lithium oxide and bismuth oxide are added to the ingredients as sintering aids, and they combine with TiO₂ to form a eutectic material Li₂TiO₃) (900° C. In this method, adding all the raw materials during the pre-calcination may lead to uncontrollable reactions among the components during pre-calcination, and the generated phases may be complex and uncertain. Further, the dielectric constant of its material is 9.5±0.1, and the Q×f value is low. The dielectric constants of the materials described in the above patents all exceed 9, which limits their applications in low-dielectric and high-frequency scenarios. Patent CN 200410039848.1 reports the formula and preparation process of low-temperature sintering microwave dielectric ceramics with (Ca.Mg) SiO₃ system as the main component. CaTiO₃ used to adjust the frequency temperature coefficient, and Li₂CO₃ and V₂O₅ as sintering aids. The low-temperature sintering microwave dielectric ceramic material can achieve good co-firing as matched with the silver electrode. Its material properties: dielectric constant 8 to 10, quality factor Qf>25000 GHz, and this material has been applied in batches. However, this material has the following problems: (1) The low melting point oxide V₂O₅ has an excellent sintering effect and can significantly reduce the sintering temperature of (Ca. Mg) SiO₃ ceramics. However, it is highly toxic and harmful to the human body and cannot meet the increasingly important environmental protection needs. (2) While V₂O₅ forms a liquid phase during the sintering process to promote ceramic sintering, it can also easily promote the short-distance diffusion of silver electrodes, which can easily lead to the risk of interlayer circuit short circuit caused by silver migration, which will lead to major hidden dangers of poor product reliability.

### SUMMARY

To solve the above technical problems, the first object of the disclosure is to provide a low-dielectric wollastonite based low-temperature co-fired ceramic material having a lower dielectric constant, a higher Q×f value, and a lower frequency temperature coefficient, and capable of achieving low-temperature sintering. The second object of the disclosure is to provide a low-dielectric wollastonite based low-temperature co-fired ceramic material and a preparation method therefor adopting a synthesis route of first synthesizing the main phase ceramics, then preparing an oxide sintering aid, and finally performing low-temperature sintering. The preparation method has a simple sintering process and good repeatability.

To achieve the first object of the disclosure mentioned above, the following technical solutions are adopted in the disclosure:

The disclosure provides a low-dielectric wollastonite based low-temperature co-fired ceramic material, and a formula expression of the low-temperature co-fired ceramic material is: CaₓSiO₃+awt % SiO₂+bwt % R₂O+cwt % Bi₂O₃+dwt % B₂O₃+ewt % MO, where 0.9≤x≤1.1.

0<a≤30, 1≤b≤5, 0<c≤3, 0<d≤6, and 0≤e≤10, and a, b, c, d, and e are mass fractions of SiO₂. RO, Bi₂O₃, B₂O₃, and MO phases in CaₓSiO₃ respectively,

R₂O is at least one of Li₂O and K₂O.

MO is one or more of ZnO, MgO, BaO, CoO, CuO, La₂O₃, and MnO₂, and

SiO₂ is at least one of quartz and fused quartz.

As a preferred solution, a composition of the main phase ceramic material is: CaₓSiO₃, and 0.9≤x≤1.0.

As a preferred solution, the SiO₂ is fused quartz.

To achieve the second object of the disclosure mentioned above, the following technical solutions are adopted in the disclosure:

The disclosure further provides a preparation method for a low-dielectric wollastonite based low-temperature co-fired ceramic material, and the following steps are included.

1) Synthesis of the main phase ceramics CaₓSiO₃: raw materials CaCO₃ and SiO₂ are weighed according to the chemical formula CaₓSiO₃ metric ratio, using deionized water as a solvent, and are ball milled and mixed for 16 to 24 hours, dried and then sieved through a 40-mesh sieve, crushed evenly and then placed into an alumina crucible, calcined at 900° C. to 1300° C. for 2 to 4 hours to synthesize the main phase ceramics, and ground as a ceramic base material for later use.

2) Synthesis of a sintering aid: raw materials Li₂CO₃. K₂CO₃, Bi₂O₃, B₂O₃ or H₃BO₃. ZnO. MgO or Mg(OH)₂, BaCO₃, CoO or Co₂O₃, CuO, La₂O₃, and MnO₂/MnCO₃ are weighed according to a relative mass fraction ratio of bwt % RO+cwt % Bi₂O₃+dwt % B₂O₃+ewt % MO, absolute ethanol is added at a mass ratio of the mixture to absolute ethanol of 1:1 to 1.5, the mixture and the absolute ethanol is mixed by a wet method for 16 to 24 hours and then drying at 80° C., and the dried material is sieved through a 40-mesh sieve, placed into an alumina crucible, calcined at 500° C. to 700° C. for 2 to 4 hours, and ground and used as a sintering aid for later use. Herein. 1≤b≤5, 0<c≤3, 0<d≤6, and 0≤e≤10, and b, c, d, and e are mass fractions of RO. Bi₂O₃, B₂O₃, and MO phases in CaₓSiO₃ respectively.

3) The prepared main phase ceramics CaₓSiO₃. SiO₂, and oxide sintering aid are mixed according to the mass ratio of CaₓSiO₃+awt % SiO₂+bwt % RO+cwt % Bi₂O₃+dwt % B₂O₃+ewt % MO. ZrO₂ balls are used as a grinding medium, ethanol is used as a solvent, and the mixture is dried after ball milling for 16 to 24 hours, added with a polyvinyl alcohol binder with a weight content of 5% to 8% for grinding and granulation, sieved and then pressed under a pressure of 80 MPa to 120 MPa into a green body with a diameter of 20 mm and a thickness of 10 mm, and sintered in an air atmosphere of 850° C. to 950° C. for 1 to 3 hours, and the low-dielectric wollastonite based low-temperature co-fired ceramic material is thus obtained. Herein, a, b, c, d, and e are mass fractions of SiO₂, RO, Bi₂O₃, B₂O₃, and MO phases in CaₓSiO₃ respectively.

Compared to the related art, the disclosure has the following advantages.

1. The disclosure provides a simple, reliable, and low-cost preparation method. The main phase ceramics and sintering aid are synthesized separately, and then the low-temperature co-fired ceramics are prepared. This method ensures that the composition of the main phase ceramic phase is controllable, and also ensures that the sintering aid synthesizes compounds such as Li₂O(K₂O)—Bi₂O₃—B₂O₃ with a lower eutectic point (less than 700° C.). Compared to the related art, the main phase ceramics synthesized by this method are easier to control, the eutectic point compound has better cooling effect, and better dielectric properties are provided.

2. This patent designs and optimizes the calcium-to-silicon ratio of the main phase ceramics and studies its impact on the dielectric properties of the material. In particular, when 0.9≤x≤1 in the main phase ceramics CaₓSiO₃, the dielectric properties of the material are better. This is because during the pre-sintering process, in addition to the wollastonite phase (CaSiO₃), some Ca₂SiO₄ phases with large dielectric losses are also generated. Therefore, excess SiO₂ is beneficial to promote the synthesis of wollastonite phase and also improves the dielectric properties of the material.

3. Using fused quartz and CaₓSiO₃ ceramics for composite, on the one hand, the dielectric constant of fused quartz is small, so that the dielectric constant of the material is effectively reduced. On the other hand, fused quartz easily forms a liquid phase during the sintering process, so it can moisten the powder particles and promote sintering.

4. In the disclosure, by introducing composite oxides for collaborative cooling and controlling the addition amounts of alkali metal oxides and Bi₂O₃, the risk of interlayer circuit short circuit caused by silver migration that easily occurs when ceramic materials and silver electrodes are co-fired is avoided. Further, in order to avoid the complex and difficult-to-control batch stability glass aid preparation process, the introduced various sintering aid oxides are pre-mixed and calcined. In this way, during the preparation of ceramic casting slurry, the cross-linking reaction among oxides such as B₂O₃, the free hydroxyl groups in the powder, and the hydroxyl groups in the binder such as PVB, resulting in a high viscosity of the slurry and the inability to obtain high-quality green ceramic tiles, is solved.

5. The disclosure provides a low-dielectric wollastonite based low-temperature co-fired ceramic material with a dielectric constant less than 7.5, a Q×f value greater than 20.000 GHz, and an absolute value of frequency temperature coefficient less than 35 ppm/° C. The requirements of low dielectric constant, low loss, and lower frequency temperature coefficient required for a millimeter wave device are satisfied.

### BRIEF DESCRIPTION OF THE DRAWINGS

The accompanying drawings, which constitute a part of the present application, are included to provide a further understanding of the present application. The illustrative embodiments and description of the present application are used to explain the present application and do not constitute a limitation of the present application.

FIG. 1 is an XRD diffraction pattern of ceramics in Example 2.

FIG. 2 is an SEM scanning electron microscope image of a fired ceramic sample in Example 4.

### DESCRIPTION OF THE EMBODIMENTS

The embodiments of the disclosure are provided in detail as follows. Examples of the embodiments are shown in the accompanying drawings. The embodiments described below with reference to the accompanying drawings are exemplary and are intended to explain the disclosure, but should not be construed as limiting the disclosure.

In order to make the objectives, technical solutions, and advantages of the disclosure clearer and more comprehensible, the disclosure is further described in detail with reference to the accompanying drawings and embodiments. It should be understood that the specific embodiments described herein serve to explain the disclosure merely and are not used to limit the disclosure.

### Example 1

1) Main phase synthesis: raw materials CaCO₃ and quartz were weighed according to the chemical formula Ca_{0.98}SiO₃ metric ratio, using deionized water as the solvent, ball milled and mixed for 24 hours, dried and sieved through a 40 mesh sieve, crushed evenly, put into an alumina crucible, and then calcined at 1200° C. for 3 hours to synthesize the main phase ceramic.

2) Synthesis of a sintering aid: raw materials such as Li₂CO₃, Bi₂O₃, H₃BO₃, and ZnO were weighed according to the mass ratio of fraction 3 wt % Li₂O+2 wt % Bi₂O₃+3 wt % B₂O₃+3 wt % ZnO relative to the main phase ceramic, absolute ethanol was added at a mass ratio of 1:1 between the mixture and absolute ethanol, the mixture was mixed by a wet method for 16 hours and then dried at 80° C., and the dried mixture was sieved through a 40-mesh sieve, put into an alumina crucible, calcined at 600° C. for 3 hours, and then ground and used as a sintering aid for later use.

3) Fused quartz accounting for 3.0 wt % of the mass percentage of the main phase ceramics and the sintering aid synthesized in the previous step were added to the main phase ceramics Ca_{0.98}SiO₃ for mixing. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 850° C. for 3 hours and its dielectric properties were tested.

### Example 2

1) Main phase synthesis: raw materials CaCO₃ and quartz were weighed according to the chemical formula CaSiO₃ metric ratio, using deionized water as the solvent, ball milled and mixed for 24 hours, dried and sieved through a 40 mesh sieve, crushed evenly, put into an alumina crucible, and then calcined at 1250° C. for 3 hours to synthesize the main phase ceramic.

2) Synthesis of a sintering aid: raw materials such as Li₂CO₃, K₂CO₃, Bi₂O₃, H₃BO₃, BaCO₃, and MnO₂ were weighed according to the mass fraction ratio of 1.5 wt % Li₂O+1 wt % K₂O+0.5 wt % Bi₂O₃+2.5 wt % B₂O₃+3 wt % BaO+2 wt % MnO₂ relative to the main phase ceramic, absolute ethanol was added at a mass ratio of 1:1 between the mixture and absolute ethanol, the mixture was mixed by a wet method for 16 hours and then dried at 80° C., and the dried mixture was sieved through a 40-mesh sieve, put into an alumina crucible, calcined at 650° C. for 3 hours, and then ground and used as a sintering aid for later use.

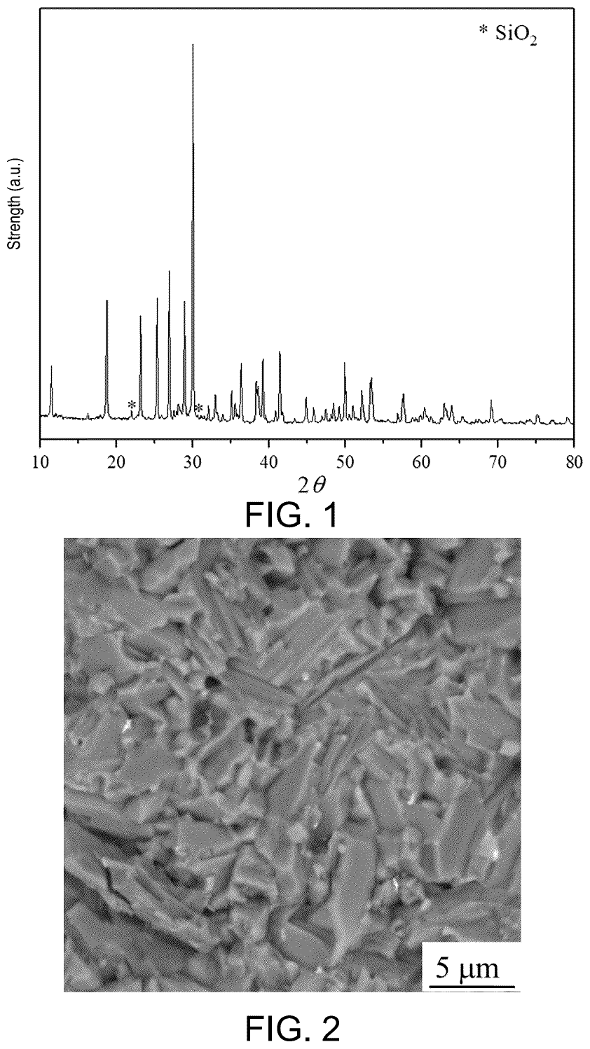

3) Fused quartz accounting for 3.5 wt % of the mass percentage of the main phase ceramics and the sintering aid synthesized in the previous step were added to the main phase ceramics CaSiO₃ for mixing. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 900° C. for 3 hours and its dielectric properties were tested. FIG. 1 shows the XRD pattern of the ceramics after sintering, and the main phase of the ceramics is CaSiO₃ and a small amount of SiO₂ phase.

### Example 3

1) Main phase synthesis: raw materials CaCO₃ and quartz were weighed according to the chemical formula Ca_{1.02}SiO₃ metric ratio, using deionized water as the solvent, ball milled and mixed for 24 hours, dried and sieved through a 40 mesh sieve, crushed evenly, put into an alumina crucible, and then calcined at 1300° C. for 3 hours to synthesize the main phase ceramic.

2) Synthesis of a sintering aid: raw materials such as Li₂CO₃, Bi₂O₃, H₃BO₃, and MgO were weighed according to the mass fraction ratio of 2.5 wt % Li₂O+1 wt % Bi₂O₃+2.5 wt % B₂O₃+2 wt % MgO relative to the main phase ceramic, absolute ethanol was added at a mass ratio of 1:1 between the mixture and absolute ethanol, the mixture was mixed by a wet method for 16 hours and then dried at 80° C., and the dried mixture was sieved through a 40-mesh sieve, put into an alumina crucible, calcined at 700° C. for 3 hours, and then ground and used as a sintering aid for later use.

3) Fused quartz accounting for 5.0 wt % of the mass percentage of the main phase ceramics and the sintering aid synthesized in the previous step were added to the main phase ceramics Ca_{1.02}SiO₃ for mixing. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 850° C. for 3 hours and its dielectric properties were tested.

### Example 4

1) Main phase synthesis: raw materials CaCO₃ and quartz were weighed according to the chemical formula CaSiO₃ metric ratio, using deionized water as the solvent, ball milled and mixed for 24 hours, dried and sieved through a 40 mesh sieve, crushed evenly, put into an alumina crucible, and then calcined at 1200° C. for 3 hours to synthesize the main phase ceramic.

2) Synthesis of a sintering aid: raw materials such as Li₂CO₃, Bi₂O₃, H₃BO₃, La₂O₃, and CuO were weighed according to the mass fraction ratio of 4 wt % Li₂O+1.5 wt % Bi₂O₃+4 wt % B₂O₃+1 wt % La₂O₃+2 wt % CuO relative to the main phase ceramic, absolute ethanol was added at a mass ratio of 1:1 between the mixture and absolute ethanol, the mixture was mixed by a wet method for 16 hours and then dried at 80° C., and the dried mixture was sieved through a 40-mesh sieve, put into an alumina crucible, calcined at 600° C. for 3 hours, and then ground and used as a sintering aid for later use.

3) Fused quartz accounting for 2.0 wt % of the mass percentage of the main phase ceramics and the sintering aid synthesized in the previous step were added to the main phase ceramics CaSiO₃ for mixing. ZrO₂ balls were used as a grinding medium and ethanol was used as the solvent. The ball-milled mixture was dried for 16 hours added with a polyvinyl alcohol binder with a weight content of 8% for grinding and granulation, sieved and then pressed under a pressure of 100 MPa to form a green body with a diameter of 20 mm and a thickness of 10 mm. The low-temperature co-fired ceramic material was obtained by sintering in an air atmosphere at 880° C. for 3 hours and its dielectric properties were tested. FIG. 2 is a scanning electron microscope photo of a cross-section of a ceramic sample. It can be seen that this low-temperature co-fired ceramics have better compactness.

### Example 5

1) Main phase synthesis: raw materials CaCO₃ and fused quartz were weighed according to the chemical formula Ca_{0.95}SiO₃ metric ratio, using deionized water as the solvent, ball milled and mixed for 24 hours, dried and sieved through a 40 mesh sieve, crushed evenly, put into an alumina crucible, and then calcined at 1100° C. for 3 hours to synthesize the main phase ceramic.

2) Synthesis of a sintering aid: raw materials such as Li₂CO₃, Bi₂O₃, H₃BO₃, CoO, and CuO were weighed according to the mass fraction ratio of 3.75 wt % Li₂O+2.5 wt % Bi₂O₃+3.75 wt % B₂O₃+1 wt % CoO relative to the main phase ceramic, absolute ethanol was added at a mass ratio of 1:1 between the mixture and absolute ethanol, the mixture was mixed by a wet method for 16 hours and then dried at 80° C. and the dried mixture was sieved through a 40-mesh sieve, put into an alumina crucible, calcined at 650° C. for 3 hours, and then ground and used as a sintering aid for later use.

3) Fused quartz accounting for 10.0 wt % of the mass percentage of the main phase ceramics and the sintering aid synthesized in the previous step were added to the main phase ceramics Ca_{0.95}SiO₃ for mixing. ZrO₂ balls were used as a grinding medium and ethanol was used as the solvent. The ball-milled mixture was dried for 16 hours, added with a polyethylene binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 850° C. for 3 hours and its dielectric properties were tested.

### Example 6

Quartz with a mass percentage of 10.0 wt % of the main phase ceramics and the sintering aid synthesized in Example 5 were added to the main phase ceramics Ca_{0.95}SiO₃ synthesized in Example 5 for mixing. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 880° C. for 3 hours and its dielectric properties were tested.

### Example 7

Fused quartz with a mass percentage of 7.0 wt % of the main phase ceramics and the sintering aid synthesized in Example 2 were added to the main phase ceramics CaSiO₃ synthesized in Example 5 for mixing. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 850° C. for 3 hours and its dielectric properties were tested.

### Comparative Example 1

The main phase ceramics CaSiO₃ synthesized in Example 2 and the sintering aid synthesized in Example 2 were mixed. ZrO₂ balls were used as a grinding medium and ethanol was used as the solvent. The ball-milled mixture was dried for 16 hours, added with a polyvinyl alcohol binder with a weight content of 8% for grinding and granulation, sieved, and then pressed under a pressure of 100 MPa to form a green body with a diameter of 20 mm and a thickness of 10 mm. The low-temperature co-fired ceramic material was obtained by sintering in an air atmosphere at 930° C. for 3 hours and its dielectric properties were tested.

Table 1 is the material dielectric property test results corresponding to the Comparative Example and Examples 1 to 7. Herein, the dielectric properties are measured using the Agilent 8719ET network analyzer to test the dielectric constant & and the Q×f value. The frequency temperature coefficient of the sample tf=(f110-f25)/(f25×85) is calculated and determined, where f110 and f25 are the resonant center frequencies of the sample at 110° C. and 25° C. respectively.

TABLE 1
Dielectric property test results of
Examples and Comparative Example

| No. | ∈ᵣ | Q × f (GHz) | τ_{f}(ppm/° C.) |
|---|---|---|---|
| 1 | 6.68 | 24200 | −25.9 |
| 2 | 6.85 | 22400 | −30.3 |
| 3 | 7.26 | 21600 | −34.8 |
| 4 | 6.92 | 22870 | −28.6 |
| 5 | 6.40 | 21730 | −23.7 |
| 6 | 6.45 | 20350 | −25.2 |
| 7 | 6.60 | 20900 | −27.5 |
| Comparative Example 1 | 7.04 | 18580 | −38.2 |

The low-temperature co-fired ceramic materials listed in the above table have a dielectric constant less than 7.5, a Q×f value greater than 20,000 GHz, and an absolute value of frequency temperature coefficient less than 35 ppm/° C. The requirements of low dielectric constant, low loss, and lower frequency temperature coefficient required for a millimeter wave device are satisfied. Compared with the Comparative Example, the introduction of fused quartz may not only reduce the sintering temperature, but also increase the Q×f value of the material and improve the frequency temperature coefficient.

It should be noted that in the description of the disclosure, the terms “include”, “comprise”, etc. are intended to cover non-exclusive inclusion, and also include processes, methods, raw materials, etc. of other elements that are not explicitly listed. “An embodiment” or a “particular embodiment” or the like means that a particular feature, structure, material or characteristic described in connection with the embodiment is included in at least one embodiment of the disclosure.

Therefore, although specific embodiments have been used to illustrate the disclosure above, it can be understood that the abovementioned embodiments are used to understand the methods and core matters of the disclosure and cannot be understood as limitations of the disclosure. A person having ordinary skill in the art may make changes, corrections, substitutions, and modifications to the abovementioned embodiments within the scope of the disclosure without departing from the principle and purpose of the disclosure, and any simple corrections, equivalent changes, and modifications made to the above embodiments based on the technical essence of the disclosure still fall within the protection scope of the disclosure.

1. A low-dielectric wollastonite based low-temperature co-fired ceramic material, wherein a formula expression of the low-temperature co-fired ceramic material is: CaₓSiO₃+awt % SiO₂+bwt % R₂O+cwt % Bi₂O₃+dwt % B₂O₃+ewt % MO, wherein
0.9≤x≤1.1,
0<a≤30, 1≤b≤5, 0<c≤3, 0<d≤6, and 0≤e≤10, a, b, c, d, and e are mass fractions of SiO₂, RO, Bi₂O₃, B₂O₃, and MO phases in CaₓSiO₃ respectively,
R₂O is at least one of Li₂O and K₂O,
MO is one or more of ZnO, MgO, BaO, CoO, CuO, La₂O₃, and MnO₂, and
SiO₂ is at least one of quartz and fused quartz.

2. The low-dielectric wollastonite based low-temperature co-fired ceramic material according to claim 1, wherein a composition of the main phase ceramic material is: CaₓSiO₃, and 0.9≤x≤1.0.

3. The low-dielectric wollastonite based low-temperature co-fired ceramic material according to claim 1, wherein the SiO₂ is fused quartz.

4. A preparation method for the low-dielectric wollastonite based low-temperature co-fired ceramic material according to claim 1, comprising:
1) synthesis of a main phase ceramics CaₓSiO₃: weighing raw materials CaCO₃ and SiO₂ according to a chemical formula CaₓSiO₃ metric ratio, using deionized water as a solvent, and ball milling and mixing for 16 to 24 hours, drying and then sieving through a 40-mesh sieve, crushing evenly and then placing into an alumina crucible, calcining at 900° C. to 1300° C. for 2 to 4 hours to synthesize the main phase ceramics, and grinding as a ceramic base material for later use;
2) synthesis of a sintering aid: weighing raw materials Li₂CO₃, K₂CO₃, Bi₂O₃, B₂O₃ or H₃BO₃, ZnO, MgO or Mg(OH)₂, BaCO₃, CoO or Co₂O₃, CuO, La₂O₃, and MnO₂/MnCO₃ according to relative mass fraction ratio a of bwt % RO+cwt % Bi₂O₃+dwt % B₂O₃+ewt % MO, adding absolute ethanol at a mass ratio of the mixture to absolute ethanol of 1:1 to 1.5, mixing the mixture and absolute ethanol by a wet method for 16 to 24 hours and then drying at 80° C., sieving the dried material through a 40-mesh sieve, placing it into an alumina crucible, calcining it at 500° C. to 700° C. for 2 to 4 hours, grinding and then using it as a sintering aid for later use, wherein 1≤b≤5, 0<c≤3, 0<d≤6, 0≤e≤10, and b, c, d, and e are mass fractions of RO, Bi₂O₃, B₂O₃, and MO phases in CaₓSiO₃ respectively; and
3) mixing the prepared main phase ceramics CaₓSiO₃SiO₂, and oxide sintering aid according to the mass ratio of CaₓSiO₃+awt % SiO₂+bwt % RO+cwt % Bi₂O₃+dwt % B₂O₃+ewt % MO, using ZrO₂ balls as a grinding medium, using ethanol as a solvent, and drying the mixture after ball milling for 16 to 24 hours, adding a polyvinyl alcohol binder with a weight content of 5% to 8% for grinding and granulation, after sieving, pressing under a pressure of 80 MPa to 120 MPa into a green body with a diameter of 20 mm and a thickness of 10 mm, and sintering in an air atmosphere of 850° C. to 950° C. for 1 to 3 hours to obtain the low-dielectric wollastonite based low-temperature co-fired ceramic material, wherein a, b, c, d, and e are mass fractions of SiO₂, RO, Bi₂O₃, B₂O₃, and MO phases in CaₓSiO₃ respectively.
